(19) United States
(12) Patent Application Publication
(10) Pub. No.: US 2014/0162118 A1
(43) Pub. Date: Jun. 12, 2014

(54) ELECTRODE STRUCTURE OF LITHIUM ION BATTERY

(71) Applicant: INDUSTRIAL TECHNOLOGY RESEARCH INSTITUTE, Hsinchu (TW)

(72) Inventors: Wen-Bing CHU, Hsinchu City (TW); Dar-Jen LIU, Zhongli City (TW); Chen-Chung CHEN, Taichung City (TW); Li-Chun CHEN, Keelung City (TW); Shih-Tswen TSENG, Beidou Township (TW); Shu-Heng WEN, Baoshan Township (TW); Chang-Rung YANG, Hsinchu City (TW)

(73) Assignee: INDUSTRIAL TECHNOLOGY RESEARCH INSTITUTE, Hsinchu (TW)

(21) Appl. No.: 13/935,079

(22) Filed: Jul. 3, 2013

(30) Foreign Application Priority Data
Dec. 10, 2012 (TW) 101146439

(51) Int. Cl. H01M 4/131

(52) U.S. Cl. CPC H01M 4/131
USPC 429/211

(57) ABSTRACT

An electrode structure of a lithium ion battery includes a current collector, at least one energy type active layer, and at least one power type active layer. The energy type active layer and the power type active layer are formed on the current collector. The energy type active layer includes a first lithium-containing compound and multiple first conductive particles. The power type active layer includes a second lithium-containing compound and multiple second conductive particles. The first and second lithium-containing compounds are lithium-containing complex transitional metal oxides. Compositions of the first and second lithium-containing compounds include at least one of Ni, Co and Mn. A lithium ion diffusion coefficient of the second lithium-containing compound is greater than that of the first lithium-containing compound. A specific capacity of the first lithium-containing compound is greater than that of the second lithium-containing compound.

This application claims the benefit of Taiwan application Serial No. 101146439, filed Dec. 10, 2012, the disclosure of which is incorporated by reference herein in its entirety.

### TECHNICAL FIELD

The disclosure relates in general to an electrode structure of a lithium ion battery, and more particularly to an electrode structure having an energy type active layer and a power type active layer for a lithium ion battery.

### BACKGROUND

With surging oil prices and the emergence of carbon reduction awareness, electric vehicles are gradually becoming a rising focus in the market. Electric vehicles are available in hybrid vehicles (including plug-ins) and pure electric vehicles. A powering system of an electric vehicle is generally formed by three main components, namely a battery module type, power unit control and motor transmission. A vehicle battery is the primary core power source of an electric vehicle. In other words, the performance of an electric vehicle greatly depends on the performance of the battery powering the vehicle.

Lithium ion batteries are commonly utilized as vehicle batteries. Therefore, extensive researches are dedicated to increasing energy density, power density, safety and cycle life of lithium ion batteries in order to enhance the performance of vehicle batteries.

### SUMMARY

The disclosure is directed to an electrode structure of a lithium ion battery. The electrode structure of a lithium ion battery comprises a multi-layer structure formed by at least one energy type active layer and at least one power type active layer. By incorporating a first lithium-containing compound of the energy type active layer with a high lithium ion transmission efficiency of a second lithium-containing compound of the power type active layer, the electrode structure is not only capable of performing high-efficiency discharge but also offered with a prolonged cycle life.

According to an embodiment of the disclosure, an electrode structure of a lithium ion battery is provided. The electrode structure comprises a current collector, at least one energy type active layer, and at least one power type active layer. The energy type active layer and the power type active layer are formed on the current collector. The energy type active layer comprises a first lithium-containing compound and a plurality of first conductive particles. The power type active layer comprises a second lithium-containing compound and a plurality of second conductive particles. The first and second lithium-containing compounds are lithium-containing complex transitional metal oxides. Compositions of the first and second lithium-containing compounds include independently at least one of nickel (Ni), cobalt (Co), or manganese (Mn). A lithium ion diffusion coefficient of the second lithium-containing compound is greater than that of the first lithium-containing compound. A specific capacity of the first lithium-containing compound is greater than that of the second lithium-containing compound.

### BRIEF DESCRIPTION OF THE DRAWINGS

FIG. 1 is a schematic diagram of an electrode structure of a lithium ion battery according to a first embodiment of the present disclosure.

FIG. 2 is a schematic diagram of an electrode structure of a lithium ion battery according to a second embodiment of the present disclosure.

FIG. 3 is a schematic diagram of an electrode structure of a lithium ion battery according to a third embodiment of the present disclosure.

FIG. 4 is a schematic diagram of an electrode structure of a lithium ion battery according to a fourth embodiment of the present disclosure.

FIG. 5 is a schematic diagram of an electrode structure of a lithium ion battery according to a fifth embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

In an embodiment of the disclosure, an electrode structure of a lithium ion battery comprises a multi-layer structure formed from at least one energy type active layer and at least one power type active layer. By incorporating a first lithium-containing compound of the energy type active layer with a high lithium ion transmission efficiency of a second lithium-containing compound of the power type active layer, the electrode structure is not only capable of performing high-efficiency discharge but also offered with a prolonged cycle life. Details of embodiments are to be described with reference to the accompanying drawings. In the drawings, same denotations represent the same or similar elements. It should be noted that the drawings are simplified for clear illustrations of the embodiments, and specific details disclosed in the embodiments are for examples for explaining the disclosure and are not to be construed as limitations. A person having ordinary skill in the art may modify or change corresponding structures according to actual applications.

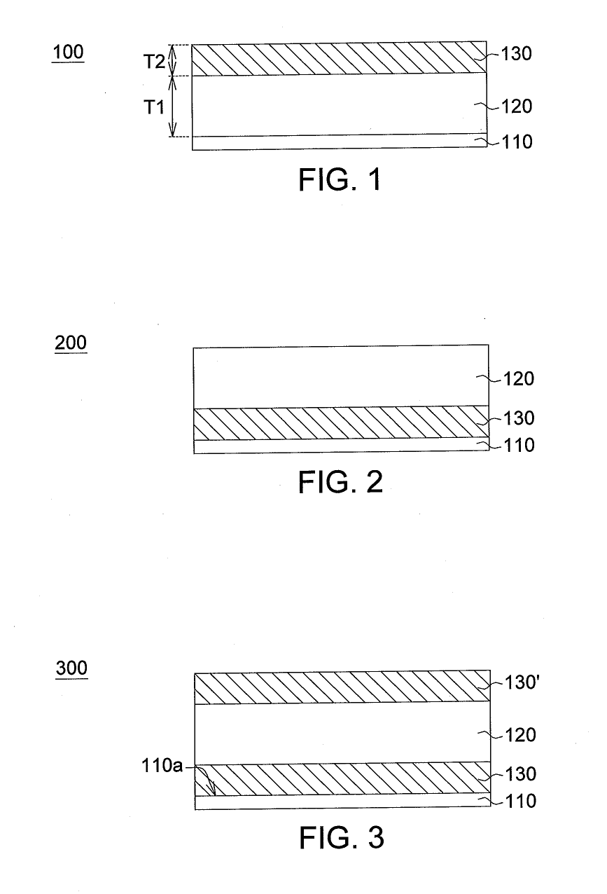

FIG. 1 shows a schematic diagram of an electrode structure of a lithium ion battery according to a first embodiment of the present disclosure. Referring to FIG. 1, an electrode structure 100 of a lithium ion battery comprises a current collector 110, at least one energy type active layer 120 and at least one power type active layer 130. The energy type active layer 120 and the power type active layer 130 are formed on the current collector 110. The energy type active layer 120 comprises a first lithium-containing compound and a plurality of first conductive particles. For example, the first lithium-containing compound is a lithium-containing complex transitional metal oxide. The composition of the lithium-containing complex transitional metal oxide (the first lithium-containing compound) includes at least one of nickel (Ni), cobalt (Co) or manganese (Mn). The power type active layer 130 comprises a second lithium-containing compound and a plurality of second conductive particles. For example, the second lithium-containing compound is a lithium-containing complex transitional metal oxide. The composition of the lithium-containing complex transitional metal oxide (the second lithium-containing compound) includes at least one of Ni, Co or Mn. A lithium ion diffusion coefficient of the second lithium-containing compound is greater than that of the first lithium-containing compound. A specific capacity of the first lithium-containing compound is greater than that of the second lithium-containing compound. With the multi-layer structure formed from the at least one energy type active layer 120 and the at least one power type active layer 130, by incorporating the first lithium-containing compound with a high ion transmission efficiency of the second lithium-containing compound, the electrode structure 100 of a lithium ion battery is not only capable of performing high-efficiency discharge but offered with a prolonged cycle life.

According to an embodiment of the disclosure, the electrode structure 100 is a cathode of lithium ion battery. However, in applications, electrode structure 100 of a lithium ion battery may be cathode or anode, which is depending on the conditions applied and not limited thereto.

In the embodiment, one of the energy type active layer 120 and the power type active layer 130 is formed on the other. In one embodiment, as shown in FIG. 1, the power type active layer 130 is formed on the energy type active layer 120, and the energy type active layer 120 is formed between the current collector 110 and the power type active layer 130.

In the embodiment, the energy type active layer 120 and the power type active layer 130 may have the same thickness or different thicknesses. For example, the ratio of the thickness of the energy type active layer 120 to the thickness of the power type active layer 130 may be 5:5 to 7:3. In one embodiment, as shown in FIG. 1, for example, the thickness T1 of the energy type active layer 120 is greater than the thickness T2 of the power type active layer 130. Since the energy type active layer 120 has a higher capacity than that of the power type active layer 130, the optimization of the high-power and high-capacity characteristics of the electrode structure 100 can be achieved, and the overall capacity of the electrode structure 100 will not be reduced caused by a large thickness of the power type active layer 130

In the embodiment, the specific capacity of the first lithium-containing compound may be greater than or equal to 140 mAh/g.

In the embodiment, the first lithium-containing compound includes, for example, one or a combination of two or more of lithium cobalt oxide (LiCoO₂), lithium nickel oxide (LiNiO₂), lithium manganese oxide (LiMn₂O₄), a lithium-containing ternary oxide and a lithium phosphate compound. In the embodiment, the lithium-containing ternary oxide may be lithium manganese cobalt nickel oxide (LiMnₓCo_{y}Ni_{z}O₂), where 0<x, y, z<1, or lithium nickel cobalt aluminum oxide (LiNiₓCo_{y}Al_{z}O₂), where 0<x, y, z<1, but not limited thereto. In the embodiment, a chemical formula of a lithium phosphate compound is LiMPO₄, where M is Fe, Ni or Mn. In an embodiment, the lithium phosphate compound may be LiFePO₄. However, the selections of the type of the first lithium-containing compound may vary depending on the conditions applied and are not limited thereto.

In the embodiment, the second lithium-containing compound has a lithium ion diffusion coefficient greater than or equal to 10⁻⁷ cm²/s. For example, the second lithium-containing compound may be LiMn₂O₄ (a spinel structure), or other types of lithium-containing compounds. The second lithium-containing compound may be one or a combination of two or more lithium-containing compounds having a lithium ion diffusion coefficient greater than or equal to 10⁻⁷ cm²/s. In one embodiment, the second lithium-containing compound may be a compound having a three-dimensional network structure, e.g., a compound having a cubic system lattice structure, such as LiMn₂O₄ (a spinel), having a ion transmission capability greater than that of a common layer structured active material (e.g., LiNi_{1/3}Mn_{1/3}Co_{1/3}O₂). In an alternative embodiment, the second lithium-containing compound may also be a layer-structured active material with a dopant, which increases the ion transmission capability of the layer-structured active material. In the embodiment, the lithium ion diffusion coefficient of LiMn₂O₄ is approximately 10⁻⁷ cm/s, the lithium ion diffusion coefficient of LiCoO₂ and LiNi_{1/3}Mn_{1/3}Co_{1/3}O₂ is approximately 10⁻⁸ cm/s, and the lithium ion diffusion coefficient of LiFePO₄ is approximately from 10⁻¹⁰ to 10⁻¹¹ cm/s. However, in addition to the above examples, given that the lithium ion diffusion coefficient of the second lithium-containing compound is greater than that of first lithium-containing compound, the selections of the types of the first and second lithium-containing compounds may vary according to the conditions applied and are not limited thereto.

In the embodiment, the first conductive particles are uniformly mixed in the energy type active layer 120, and the second conductive particles are uniformly mixed in the power type active layer 130 to achieve a preferred electron transmission effect. For example, the first conductive particles and the second conductive particles are respectively one or a combination of two or more of vapor grown carbon fiber (VGCF), conductive carbon black, graphite, a nano-sized carbon material, and acetylene black. In the embodiment, the first conductive particles and the second conductive particles may be selected from the same or different materials. However, in addition to the above examples, the selections of the types of the first conductive particles and the second conductive particles may vary according to the conditions applied and are not limited thereto.

In one embodiment, the weight ratio of the second conductive particles to the power type active layer 130 may be 3 to 80 wt %, and may be preferably 5 to 50 wt %. In one embodiment, the second conductive particles may have a specific surface area of 10 m²/g to 100 m²/g, and preferably 20 m²/g to 70 m²/g.

In one embodiment, the weight ratio of the second conductive particles to the power type active layer 130 may be greater than the weight ratio of the first conductive particles to the energy type active layer 120. In the embodiment, the specific surface area of the second conductive particles in the power type active layer 130 is greater than the specific surface area of the first conductive particles in the energy type active layer 120.

In the embodiment, by incorporating the energy type active layer 120 having a high capacity with the second conductive particles having a high specific surface area and a high concentration in the power type active layer 130, the electron transmission capability (i.e., the electricity conductivity) can be increased. Compared to a conventional electrode structure having a single active material layer, the electrode structure according to the embodiments of the disclosure achieves a lower loss in the overall capacity under high-power discharge.

In one embodiment, the first lithium-containing compound and the second lithium-containing compound may both include lithium-containing manganese compounds. For example, the first lithium-containing compound may be LiNi_{0.4}Mn_{0.4}Co_{0.2}O₂, and the second lithium-containing compound may be LiMn₂O₄. When compositions of the lithium-containing compounds in both of the energy type active layer 120 and the power type active layer 130 include manganese, a high compatibility is provided in battery applications in contribution to the same element utilized. Further, as LiMn₂O₄ has a rather high platform voltage at about 3.9 V, that is close to an operating voltage (usually 3.7 V) of a common lithium ion battery, cross utilization and operations of products are further favored.

Further, in the embodiment, as shown in FIG. 1, the power type active layer 130 is formed on the energy type active layer 120, and both of the energy type active layer 120 and the power type active layer 130 contain lithium-containing manganese compounds. The insertion and extraction of the lithium ions cause an oxidation-reduction reaction, and so the lithium-containing manganese compound (e.g. LiMn₂O₄) in the power type active layer 130 is allowed to in advance transform into a more stable tetravalent manganese (Mn⁴⁺) layer. By the Mn⁴⁺ layer effectively protecting the lithium-containing manganese compound (e.g. lithium-containing nickel cobalt manganese compound) having a high capacity in the energy type active material layer 130 underneath, an overall amount of dissolved manganese in the electrode structure can be reduced, and hence the cycle life is prolonged. Further, due to the better chemical stability and safety of coupling of trivalent and tetravalent manganese (Mn³⁺/⁴⁺) ions over those of coupling of trivalent and tetravalent cobalt (Co³⁺/⁴⁺), the amount of trivalent and tetravalent manganese (Mn³⁺/⁴⁺) in the two-layered structure according to the embodiments of the disclosure is greater than that in a conventional single-layered electrode structure, thereby promoting the corresponding stability in an electrochemical cycle.

In the embodiment, the energy type active layer 120 and the power type active layer 130 in the electrode structure 100 of a lithium ion battery may further comprise a binder, respectively. In the embodiment, the first lithium-containing compound and the first conductive particles form the energy type active layer 120 via the binder, and the second lithium-containing compound and the second conductive particles form the power type active layer 130 via the binder.

FIG. 2 shows a schematic diagram of an electrode structure of a lithium ion battery according to a second embodiment of the present disclosure. Referring to FIG. 2, the difference of the second embodiment from the embodiment in FIG. 1 is in that, in an electrode structure 200 of a lithium ion battery, the power type active layer 130 is formed between the current collector 110 and the energy type active layer 120. Elements sharing the same labeling are the same elements. Details of the same elements can be referred from associated descriptions of the foregoing embodiment, and shall be omitted herein.

FIG. 3 shows a schematic diagram of an electrode structure of a lithium ion battery according to a third embodiment of the present disclosure. Elements sharing the same labeling are the same elements. Details of the same elements can be referred from associated descriptions of the foregoing embodiments, and shall be omitted herein.

Referring to FIG. 3, the difference of the present embodiment from the embodiments as shown in FIGS. 1 and 2 is in that, an electrode structure 300 of a lithium ion battery comprises two power type active layers 130 and 130′, which are formed on a first surface 110a of the current collector 110. The energy type active layer 120 is formed between the two power type active layers 130 and 130′. Characteristics of the power type active layer 130′, material types included in the power type active layer 130′, and material types for forming the power type active layer 130′ are the same as those for the power type active layer 130, and the related descriptions can be referred from foregoing descriptions associated with the power type active layer 130. However, the selections of the types of the lithium-containing compounds in the power type active layer 130 and in the power type active layer 130′ may vary according to the conditions applied. Given that the lithium ion diffusion coefficients of the lithium-containing compounds in the two power type active layers 130 and 130′ are greater than that of the first lithium-containing compound in the energy type active layer 120, the lithium-containing compound in the two power type active layers 130 and 130′ may be the same or different compounds.

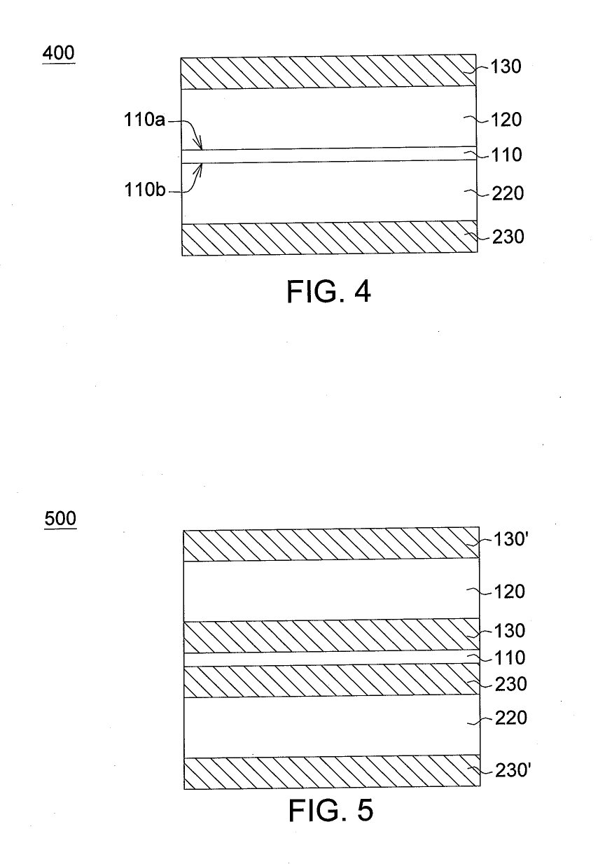

FIG. 4 shows a schematic diagram of an electrode structure of a lithium ion battery according to a fourth embodiment of the present disclosure. Elements sharing the same labeling are the same elements. Details of the same elements can be referred from associated descriptions of the foregoing embodiments, and shall be omitted herein.

Referring to FIG. 4, the difference of the present embodiment from the embodiment as shown in FIG. 1 is in that, an electrode structure 400 of a lithium ion battery comprises two energy type active layers 120 and 220 and two power type active layers 130 and 230. The two power type active layers 130 and 230 are respectively formed on a first surface 110a of the current collector 110 and a second surface 110b opposite the first surface 110a. The two energy type active layers 120 and 220 are respectively formed on the first surface 110a and the second surface 110b of the current collector 110. In one embodiment, as shown in FIG. 4, the two energy type active layers 120 and 220 are respectively located between the two power type active layers 130 and 230 and the current collector 110. In an alternative embodiment, the two power type active layers 130 and 230 may also be respectively located between the two energy type active layers 120 and 220 and the current collector 110 (not shown).

Characteristics of the energy type active layer 220, material types included in the energy type active layer 220, and material types for forming the energy type active layer 220 are the same as those of the energy type active layer 120, and can be referred from foregoing descriptions associated with the energy type active layer 120. Further, characteristics of the power type active layer 230, material types included in the power type active layer 230, and material types for forming the power type active layer 230 are same as those of the power type active layer 130, and can be referred from foregoing descriptions associated with the power type active material layer 130. However, given that the lithium ion diffusion coefficients of the lithium-containing compounds in the power type active layers 130 and 230 are greater than that of the lithium-containing compound in the energy type active layers 120 and 220, the selections of the type of the lithium-containing compounds in the energy type active layer 120, in the power type active layer 130, in the energy type active layer 220 and in the power type active layer 230 may vary according to the conditions applied and are not limited thereto.

FIG. 5 shows a schematic diagram of an electrode structure of a lithium ion battery according to a fifth embodiment of the present disclosure. Referring to FIG. 5, the difference of the present embodiment from the embodiment as shown in FIG. 4 is in that, an electrode structure 500 of a lithium ion battery further comprises two power type active layers 130′ and 230′ respectively formed on the first surface 110a and the second surface 110b of the current collector 110. In the embodiment, as shown in FIG. 5, the energy type active layer 120 is formed between the two power type active material layers 130 and 130′, and the energy type active layer 220 is formed between the two power type active layers 230 and 230′. Elements sharing the same labeling are the same elements. Details of the same elements can be referred from associated descriptions of the foregoing embodiments, and shall be omitted herein.

The embodiments of the present disclosure are further described below. In the following examples and comparison examples, electrode structures and materials are listed. However, it should be noted that the following examples are exemplifications rather than limitations to the disclosure.

1) Structural arrangement of embodiment 1 and 2: power type active layer 130 (LiMn₂O₄)/energy type active layer 120 (LiNi_{0.4}Mn_{0.4}Co_{0.2}O₂)/current collector 110.

2) Structural arrangement of comparison example 1: single-layered active layer (LiNi_{0.4}Mn_{0.4}Co_{0.2}O₂)/current collector.

3) Structural arrangement of comparison example 2: single-layered active layer (LiMn₂O₄)/current collector.

4) Structural arrangement of comparison example 3: single-layered active layer (LiMn₂O₄ and LiNi_{0.4}Mn_{0.4}Co_{0.2}O₂ mixed in the single layer)/current collector.

In Table 1, data of capacity retention of samples from the embodiments and the comparison examples are obtained under charge/discharge conditions of 1 C (charged to 4.2 V)/1 C (discharged to 2.75 V) for a charge/discharge cycle of 100 times.

TABLE 1

| | Thickness ratio (power | | | | |
|---|---|---|---|---|---|
| | type active layer 130:energy | | | | Capacity |
| | type active | C-rate capacity (mAh/g) | | | retention |
| | layer 120) | 0.5 C^{[note1]} | 3 C^{[note 1]} | 4 C^{[note 1]} | (%) |
| Embodiment 1 | 5:5 | 124.7 | 100.0 | 60.0 | 91.1 |
| Embodiment 2 | 3:7 | 133.5 | 106.5 | 63.6 | 91.5 |
| Comparison | ^{[note 2]} | 134.2^{[note 3]} | 111.8 | 46.4 | 90.1 |
| example 1 | | | | | |
| Comparison | ^{[note 2]} | 102.3 | 83.7 | 49.2 | 91.2 |
| example 2 | | | | | |
| Comparison | ^{[note 2]} | 120.0 | 98.5 | 46.2 | 82.6 |
| example 3 | | | | | |

^{[note 1]}0.5 C indicates that the current value can theoretically discharge for two hours, and 4 C indicates that the current value can theoretically discharge for 0.25 (¼) hour. That is to say, comparing 4 C and 0.5 C, 4 C is high-power discharge.
^{[note 2]}Single-layered structure.
^{[note 3]}The comparison example 1 utilizes high-energy type active materials, and thus has a higher capacity under low C-rate discharge.

As observed from Table 1, under the condition of 4 C discharge rate, the capacity of the comparison examples 1 to 3 is lower than the capacity of the embodiments 1 and 2. For example, under 4 C, the capacities of the embodiments are both above 60 mAh/g, whereas the capacitance capacities of the comparison examples are approximately at 46 to 49 mAh/g. Under a condition of a constant discharge current, for example, the discharge time of the embodiment 1 is about 0.25 hour, and the discharge time of the comparison example 1 is about 0.19 hour. Therefore, it is apparent that the electrode structure of the embodiments according to the embodiments of the present disclosure is capable of performing high-power discharge and has a longer high-power discharge period.

Further, it is also observed from Table 1 that, the capacity retention rate of the embodiments 1 and 2 are both above 90%. Thus, even after 100 times of charge/discharge, the electrode structures of the examples according to the embodiments of the present disclosure still maintain high capacity retention rates. In other words, the electrode structure of the embodiments is provided with a prolonged lifecycle even under a high-power discharge condition.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An electrode structure of a lithium ion battery, comprising:
a current collector;
at least one energy type active layer, formed on the current collector, comprising a first lithium-containing compound and a plurality of first conductive particles; and
at least one power type active layer, formed on the current collector, comprising a second lithium-containing compound and a plurality of second conductive particles;
wherein, the first lithium-containing compound and the second lithium-containing compound are lithium-containing complex transitional metal oxides; the composition of the first lithium-containing compound comprises at least one of nickel (Ni), cobalt (Co) or manganese (Mn); the composition of the second lithium-containing compound comprises at least one of Ni, Co and Mn; the second lithium-containing compound has a lithium ion diffusion coefficient greater than a lithium ion diffusion coefficient of the first lithium-containing compound; and the first lithium-containing compound has a specific capacity greater than a specific capacity of the second lithium-containing compound.

2. The electrode structure according to claim 1, wherein the specific capacity of the first lithium-containing compound is greater than or equal to 140 mAh/g.

3. The electrode structure according to claim 1, wherein the lithium-containing complex transitional metal oxides are independently lithium cobalt oxide (LiCoO₂), lithium nickel oxide (LiNiO₂), lithium manganese oxide (LiMn₂O₄), lithium-containing ternary oxide, lithium phosphate compound, or the combinations thereof.

4. The electrode structure according to claim 3, wherein the lithium-containing ternary oxide comprises lithium manganese cobalt nickel oxide (LiMnₓCo_{y}Ni_{z}O₂), where 0<x, y, z<1; lithium nickel cobalt aluminum oxide (LiNiₓCo_{y}Al_{z}O₂) where 0<x, y, z<1; or the combination thereof.

5. The electrode structure according to claim 3, wherein a chemical formula of the lithium phosphate compound is LiMPO₄, where M is Fe, Ni or Mn.

6. The electrode structure according to claim 5, wherein the lithium phosphate compound is lithium iron phosphate oxide (LiFePO₄).

7. The electrode structure according to claim 1, wherein the second lithium-containing compound comprises LiMn₂O₄, a lithium-containing compound having a lithium ion diffusion coefficient greater than or equal to 10⁻⁷ cm²/s, or the combination thereof.

8. The electrode structure according to claim 1, wherein the first conductive particles and the second conductive particles respectively comprise vapor grown carbon fiber (VGCF), conductive carbon black, graphite, a nano-sized carbon material, acetylene black, or the combinations thereof.

9. The electrode structure according to claim 1, wherein the weight ratio of the second conductive particles to the energy type active layer is 3 to 80 wt %.

10. The electrode structure according to claim 1, wherein the specific surface area of the second conductive particles is 10 to 100 m²/g.

11. The electrode structure according to claim 1, wherein the weight ratio of the second conductive particles to the power type active layer is greater than the weight ratio of the first conductive particles to the energy type active layer.

12. The electrode structure according to claim 1, wherein the specific surface area of the second conductive particles in the power type active layer is greater than the specific surface area of the first conductive particles in the energy type active layer.

13. The electrode structure according to claim 1, wherein the thickness of the energy type active layer is greater than the thickness of the power type active layer.

14. The electrode structure according to claim 1, wherein the energy type active layer is formed between the current collector and the power type active layer.

15. The electrode structure according to claim 1, wherein the power type active layer is formed between the current collector and the energy type active layer.

16. The electrode structure according to claim 1, wherein there are at least two power type active layers, one of the two power type active layers is formed on a first surface of the current collector, and the energy type active layer is formed between the two power type active layers.

17. The electrode structure according to claim 1, wherein there are at least two power type active layers and at least two energy type active layers, the two energy type active layers are respectively formed on a first surface of the current collector and a second surface opposite the first surface, and the two power type active layers are respectively formed on the first surface and the second surface of the energy type active layers.

18. The electrode structure according to claim 1, wherein there are at least four power type active layers and at least two energy type active layers, two of the four power type active layers are formed on the first surface of the current collector, the other two of the four power type active layers are formed on the second surface of the current collector, and the two energy type active layers are respectively formed on a first surface of the current collector and a second surface opposite the first surface, which is located between the two power type active layers.
